(19) United States
(12) Patent Application Publication
(10) Pub. No.: US 2015/0086071 A1
(43) Pub. Date: Mar. 26, 2015

(54) METHODS AND SYSTEMS FOR EFFICIENTLY MONITORING PARKING OCCUPANCY

(71) Applicant: XEROX CORPORATION, Norwalk, CT (US)

(72) Inventors: Wencheng Wu, Webster, NY (US); Robert P. Loce, Webster, NY (US); Edgar A. Bernal, Webster, NY (US)

(73) Assignee: XEROX CORPORATION, Norwalk, CT (US)

(21) Appl. No.: 14/033,059

(22) Filed: Sep. 20, 2013

(51) Int. Cl. G06K 9/00; G06T 15/08; G06T 7/00

(52) U.S. Cl. CPC G06K 9/00718; G06T 7/0046; G06T 15/08; G06K 9/00771; G06T 2207/10016; G06T 2207/30232; G06T 2207/30264; G06T 2215/16; G06K 2009/00738
USPC 382/103

(57) ABSTRACT

A system and method for determining parking occupancy by constructing a parking area model based on a parking area, receiving image frames from at least one video camera, selecting at least one region of interest from the image frames, performing vehicle detection on the region(s) of interest, determining that there is a change in parking status for a parking space model associated with the region of interest, and updating parking status information for a parking space associated with the parking space model.

### TECHNICAL FIELD

The present disclosure relates generally to methods, systems, and computer-readable media for monitoring parking occupancy.

### BACKGROUND

Determining and providing real-time parking occupancy data can effectively reduce fuel consumption and traffic congestion, while allowing parking lot owners to attract more customers by providing automated parking availability information to customers.

Current systems can process image data to determine real-time parking occupancy. However, processing large amounts of video data can create implementation issues that can lead to inefficiency and/or high costs. For example, processing each frame of a video can require large amounts of processing power, which may be prohibitively expensive.

Therefore, parking monitoring systems can be improved by methods and systems for using and efficiently processing video data to determine real-time parking occupancy.

### SUMMARY

The present disclosure relates generally to methods, systems, and computer readable media for providing these and other improvements to parking monitoring systems.

In some embodiments, a computing device can construct a parking area model based on a parking area and the parking area model can include at least one parking space model associated with a parking space in the parking area. Subsequently, the computing device can receive image frames from at least one video camera. The computing device can select at least one region of interest from the image frames and perform vehicle detection on the region(s) of interest. Additionally, the computing device can determine that there is a change in parking status for a parking space model associated with the region of interest and can update parking status information for a parking space associated with the parking space model.

In certain implementations, the parking area model can be a three-dimensional volumetric model and constructing the three-dimensional volumetric model can include: receiving preliminary image frames for the parking area, determining a parking lot layout based on the preliminary image frames for the parking area, estimating parking space volume for the parking space models within the parking lot layout based on a viewing angle of the video camera(s), and estimating a probability that a pixel from the preliminary image frames belongs to a particular parking space model.

In further embodiments, selecting the region of interest within an image frame can include selecting the region of interest based on detected motion between the image frame and a previous image frame. Additionally, the region of interest can be selected when the detected motion overlaps a parking space model from the parking area model.

In some embodiments, the computing device can track points of an object associated with a region of an image frame where motion is detected within the image frames and the region of interest can be selected based on a determination that a threshold number of tracking points stopped at a parking space model from the parking area model or a threshold number of tracking points leave a parking space model, from the parking area model, from which they originated.

In other embodiments, the computing device can monitor pixel intensities of pixels within each image frame and a region of interest can be selected based on a determination that pixel intensities of monitored pixels vary greater than a threshold amount between image frames, the monitored pixels are associated with at least one parking space model.

In further embodiments, the computing device can monitor pixel intensities of pixels within each image frame and a region of interest can be selected based on a determination that, between image frames, pixel intensities change from pixel intensities associated with occupied parking space models to pixel intensities associated with non-occupied parking space models or pixel intensities change from pixel intensities associated with non-occupied parking space models to a pixel intensities associated with occupied parking space models.

In still further embodiments, the computing device can monitor pixel intensities of pixels within each image frame and classify pixels as vehicle or non-vehicle in a biased probabilistic manner. The classification can be biased towards vehicle pixels relative to non-vehicle pixels when a determination is made that a threshold number of tracking points stopped at a parking space model from the parking area model. The classification can be biased towards non-vehicle pixels relative to vehicle pixels when a determination is made that a threshold number of tracking points leave a parking space model, from the parking area model, from which they originated.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a flow diagram illustrating an exemplary method of monitoring parking occupancy using a video camera, consistent with certain disclosed embodiments;

FIG. 2A is a diagram depicting a sequence of image frames from a video camera, consistent with certain disclosed embodiments;

FIG. 2B is a diagram depicting a sequence of image frames from a video camera, consistent with certain disclosed embodiments;

FIG. 2C is a diagram depicting a sequence of image frames from a video camera, consistent with certain disclosed embodiments;

FIG. 2D is a diagram depicting a sequence of image frames from a video camera, consistent with certain disclosed embodiments;

FIG. 3 is a diagram depicting a sequence of image frames from a video camera and exemplary pixel intensity values, consistent with certain disclosed embodiments; and

FIG. 4 is a diagram illustrating an exemplary hardware system for determining parking occupancy, consistent with certain disclosed embodiments.

### DETAILED DESCRIPTION

The following detailed description refers to the accompanying drawings. Wherever possible, the same reference numbers are used in the drawings and the following description refers to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

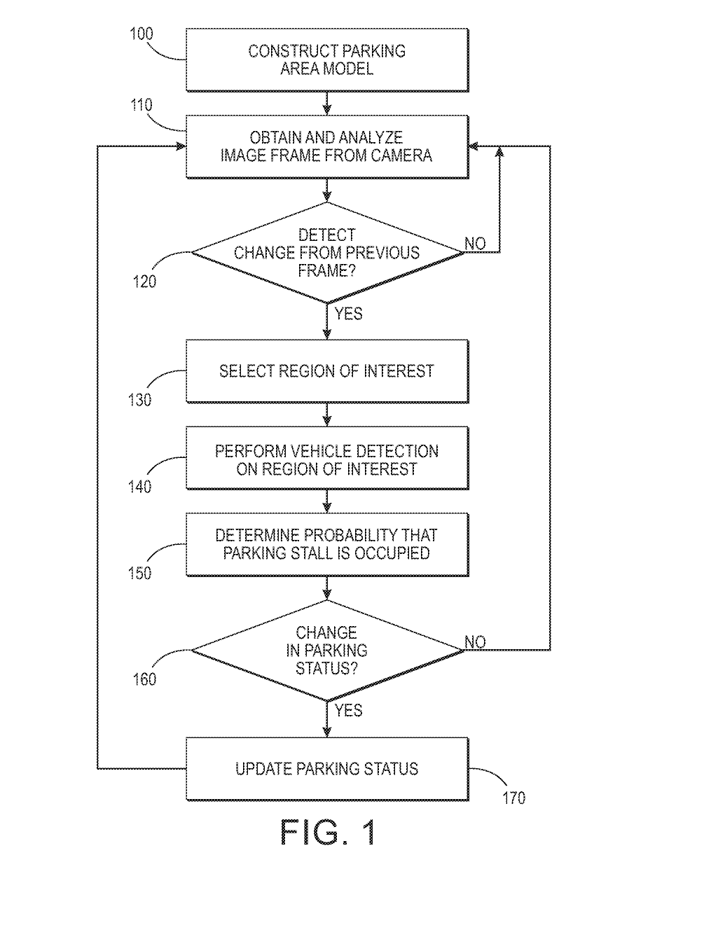

FIG. 1 is a flow diagram illustrating an exemplary method of monitoring parking occupancy using a video camera, consistent with certain disclosed embodiments. The process can begin in 100 when a computing device constructs a parking area model, for example, based on one or more image frames received from a video camera. In other embodiments, the computing device can construct a parking area model based on an existing blueprint of the parking area along with knowledge of the camera configuration parameters. Such parameters can include pose of the camera (height, angles, etc.) and the camera's intrinsic characteristics (focal length, sensor size, location of sensor center and skews, etc.).

For example, in some embodiments, the computing device can construct three-dimensional (“3-D”) volumetric models of parking spaces in the parking area. Such parking space models can be constructed using the methods taught in U.S. patent application Ser. No. 13/433,809, filed Mar. 29, 2012, which is incorporated by reference in its entirety.

The computing device can construct a 3-D volumetric model for at least one parking space by first determining a parking lot layout using the one or more image frames received from the video camera or by receiving a schematic of a parking lot layout. Second, the computing device can estimate parking space volume based on the viewing angle of the video camera. Then the computing device can estimate the probability that an observed pixel belongs to a particular parking space model (i.e., a probability density function for the observed pixel). In some embodiments, if a probability that an observed pixel belongs to a particular parking space model exceeds a threshold, the pixel can associated with the parking space model. Pixels may be associated with no parking space models, with one parking space model, or with multiple parking space models. Such estimates and associations can be stored in a database.

In some embodiments, the computing device can perform 100 once to initialize the system, while, in further embodiments, the computing device may perform 100 to initialize the system and at later intervals such as, for example, once a day, when a movement of the video camera is detected, when high error rates are detected, changes have been made in the parking area, etc.

After initializing the system in 100, in 110, the computing device can obtain and analyze an image frame from the video camera. In some embodiments, the analysis in 110 of the image frame is simpler and requires less processing resources than the analyses described below in 140 and 150. Accordingly, the computing device can process, image frame by image frame, a video received from a video camera without requiring expensive equipment and/or large amounts of processing capabilities.

For example, the computing device can compare an image frame with at least one previous image frame to perform motion detection using the frame-to-frame differencing methods. For another example, the computing device can compare the image frame with a background image frame to perform foreground object detection using background subtraction methods, where said background image frame can be determined by methods such as: a running average of previous N image frames, a weighted sum of the image frame and a previously determined background image frame, pixel-wise Gaussian-Mixture background modeling, etc. If, in 120, there is no detected motion, then the computing device can proceed to 110 and receive and analyze a subsequent image frame from the video camera. By performing motion detection, the computing device can further reduce processing costs by performing tasks that require higher processing resources only on image frames where motion is detected, instead of on every incoming image frame.

If, in 120, there is detected motion, this indicates that there may be potential changes of parking space occupancy for one or more parking spaces in the image frame. Accordingly, the computing device can further process the image frame by, in 130, selecting one or more regions of interest in the image frame. By selecting one or more regions of interest in the image frame, the computing device can further reduce processing costs by performing tasks that require higher processing resources on the regions of interest instead of the full image frame.

In some embodiments, the computing device can select the one or more regions of interest by determining if the pixels where motion was detected in 120 overlap one or more parking spaces by referencing the 3-D volumetric models. If sufficient overlap occurs with a parking space model, a region of interest encompassing the shape of that parking space model can be selected. In further embodiments, the region of interest can cover more than just the shape of the parking space model and can include, for example, a bounding box, as used in the 3-D volumetric model, that encompasses the shape of the parking space model.

In other embodiments, the computing device can perform a local tracking of points corresponding to the motion detected in 120 (i.e. a motion blob) over multiple image frames. For example, the computing device can use object tracking algorithms such as a proximity criterion in the binary domain of the foreground of the image frame. One example of proximity criterion is to associate a detected motion blob, such as that detected in 120, in one frame to the nearest detected motion blob in the next frame as the same object. Another example of proximity criterion is to associate a detected motion blob, such as that detected in 120, in one frame to the nearest detected motion blob in the next frame as the same object if the distance to the nearest detected motion blob is below a threshold. The latter is more commonly used since the thresholding step reduces the chance of abrupt tracking caused by noises. However, an inappropriate choice of threshold (e.g. value is too small) may increase the chance of losing track of objects. The computing device can track the movement from frame to frame and postpone selecting the one or more regions of interest until either: (1) a significant number of tracking points stop at one of the volumetric models of a parking space (i.e., a vehicle parking); or (2) a significant number of tracking points originate and move away from one of the volumetric models of a parking space (i.e., a parked vehicle leaving).

In still further embodiments, the computing device can continually monitor pixel intensities of pixels within each image frame of the volumetric models. For example, the computing device can monitor all of the pixels within the volumetric model of a parking space and/or, because a vehicle may not occupy a complete parking space model, the computing device can monitor a center portion of the pixels within the volumetric model of a parking space. When a variation in pixel intensities for monitored pixels exceeds a threshold, a region of interest can be selected that encloses the pixels. Additionally or alternatively, pixel intensities may be associated with occupied and non-occupied parking space models. Specifically, the characteristics of a color cluster describing the appearance of a non-occupied parking space model can be learned over time. When the color attributes of the image area associated with that parking space model are found to be significantly different (e.g., at a distance larger than a predetermined threshold) than the learned color cluster, a determination can be made that the parking space model is occupied. Accordingly, when pixel intensities within the volumetric model of a previously unoccupied parking space model diverge from the learned pixel intensities associated with an unoccupied parking space model, a region of interest enclosing the pixels may be selected. Further, when pixel intensities within the volumetric model of a previously occupied parking space model approach the learned pixel intensities associated with an unoccupied parking space model, a region of interest enclosing the pixels may be selected.

In some embodiments, illumination levels may change, causing large and uniform or partially uniform variation in pixel intensities. Accordingly, such uniform or partially uniform variations can be accounted for, and no region of interest may be selected based on such a variation. Additionally or alternatively, the computing device may select or adjust pixel intensities associated with occupied and unoccupied parking space models based on the change in illumination.

In embodiments, a computing device is not limited to using a single method for detecting motion and/or selecting regions of interest, and may use a combination of methods. For example, the computing device may predominately use a first method for selecting a region of interest, but may intermittingly use a second method to catch potential errors that are more frequent when using the first method. Additional methods for detecting motion and/or selecting regions of interest may be used, as known to those of skill in the art.

In 140, the computing device can perform vehicle detection on at least one of the regions of interest selected in 130. Accordingly, the computing device may only perform vehicle detection on a subset of the image frame and/or a sub-region(s) of the image frame, reducing the amount of processing required by the computing device.

In embodiments, the computing device can use various vehicle detection algorithms known in the art. For example, the computing device can use pixel-classification based vehicle detectors (e.g., Local Binary Patterns-Support Vector Machines [“LBP-SVM”] or TextonBoost) and/or object-recognition based vehicle detectors (e.g., Histogram of Oriented Gradients-SVM [“HOG-SVM”]).

In further embodiments, the computing device can additionally impose constraints on the pixel classifications based on how the region of interest was selected. For example, if the region of interest was selected because a significant number of tracking points stopped at one of the volumetric models of a parking space, the region of interest may have been marked as a vehicle parking in the parking space. Accordingly, the pixel classification can either remain as non-vehicle or change from non-vehicle to vehicle in a biased probabilistic manner. This biased approach dictates that among all the pixels classified by said pixel classification process, the classification decision will be biased towards vehicle pixels relative to non-vehicle pixels. This can be achieved, for example, by changing the classification thresholds, boundaries or margins that lead to a classification decision in said pixel classification process. A pixel classification change from vehicle to non-vehicle would not correspond with a vehicle parking.

Alternatively, if the region of interest was selected because a significant number of tracking points are detected leaving one of the volumetric models of a parking space, the region of interest may have been marked as a vehicle leaving a parking space. Accordingly, the pixel classification can either remain as vehicle or change from vehicle to non-vehicle in a biased probabilistic manner. This biased approach dictates that among all the pixels classified by said pixel classification process, the classification decision will be biased towards non-vehicle pixels relative to vehicle pixels. This can be achieved, for example, by changing the classification thresholds, boundaries or margins that lead to a classification decision in said pixel classification process. A pixel classification change from non-vehicle to vehicle would not correspond with a vehicle leaving a parking space.

In 150, the computing device can determine a probability that a parking space model within the at least one region of interest is occupied by a vehicle. For example, the computing device can determine such a probability using a spatially-varying membership probability density function and a likelihood of pixels classified as vehicle pixels within the region of interest, as disclosed in U.S. patent application Ser. No. 13/433,809.

In 160, the computing device can determine if the parking status of any parking spaces needs to be updated. If no changes in parking status have occurred in any parking space models, the computing device can proceed to 110 and receive another image from the video camera. If a change in parking status has occurred in at least one parking space model, the computing device can, in 170, update the parking status for each parking space associated with a parking space model where a change in parking status occurred and then proceed to 110 and receive another image frame from the video camera.

While the steps depicted in FIG. 1 have been described as performed in a particular order, the order described is merely exemplary, and various different sequences of steps can be performed, consistent with certain disclosed embodiments. Further, the steps described are not intended to be exhaustive or absolute, and various steps can be inserted or removed.

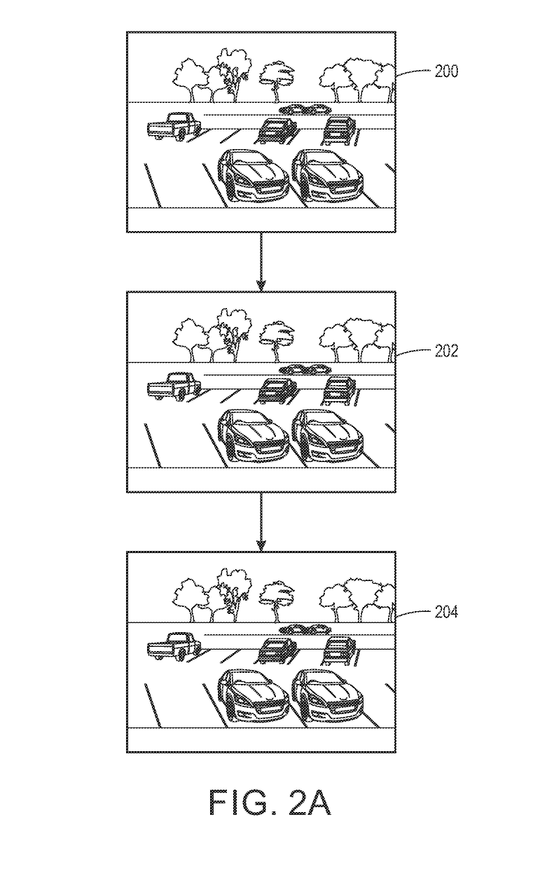

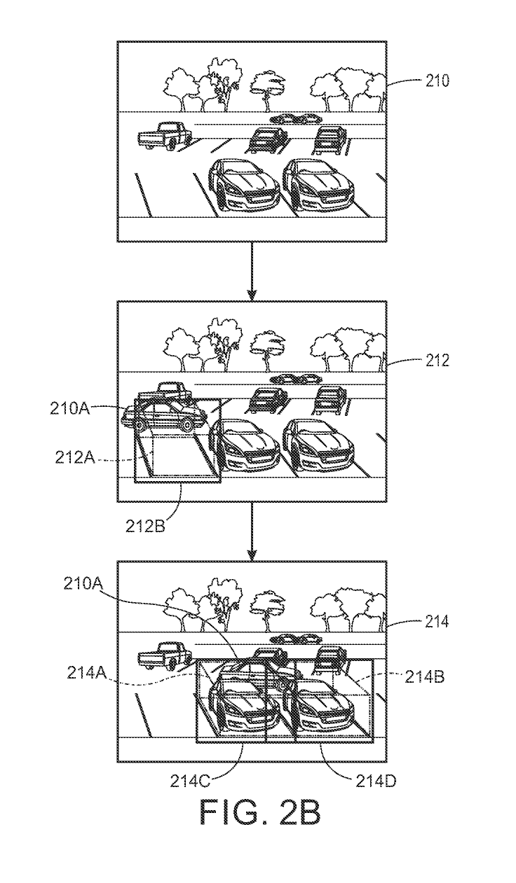

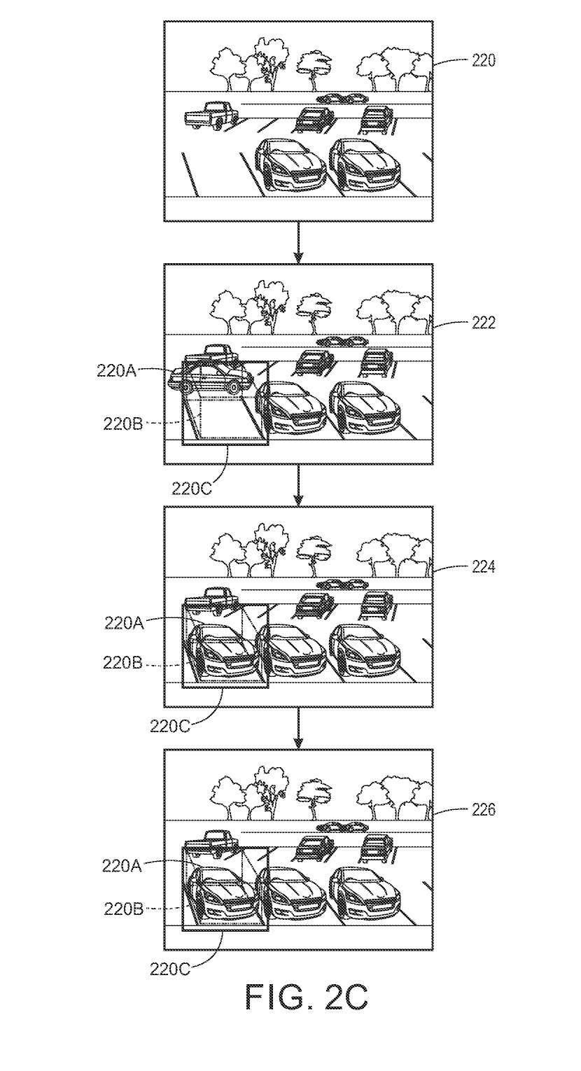

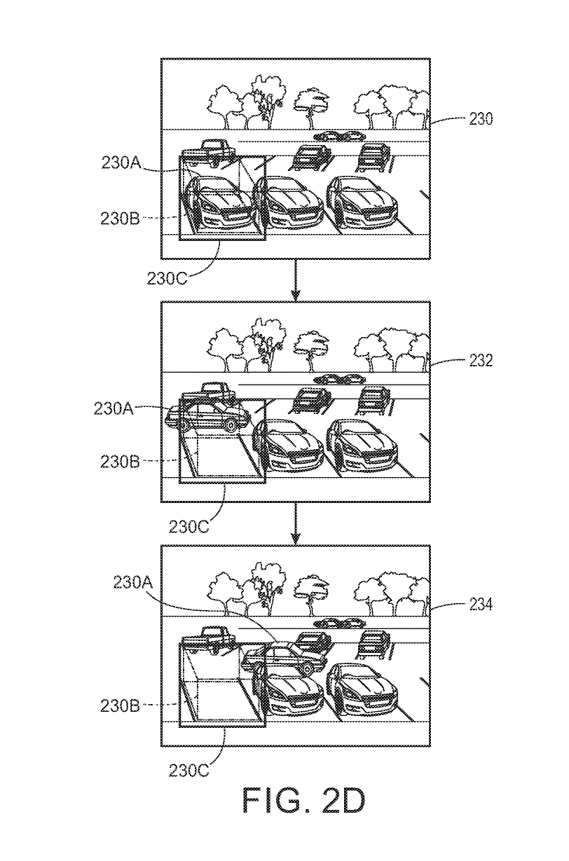

FIG. 2A is a diagram depicting a sequence of image frames from a video camera, consistent with certain disclosed embodiments. FIG. 2A is intended merely for the purpose of illustration and is not intended to be limiting.

As depicted in FIG. 2A, the sequence of image frames includes image frame 200, image frame 202, and image frame 204. Image frames 200, 202, and 204 represent image frames that can be captured by a video camera monitoring a parking lot and obtained by a computing device (e.g., 110 in FIG. 1).

For example, the computing device can first receive image frame 200 and subsequently receive image frame 202. The computing device can analyze image frame 202 (110 in FIG. 1) and perform motion detection using frame-to-frame differencing with image frame 200 and/or background subtraction methods. Because there is little to no change between image frame 200 and image frame 202, the computing device may not select a region of interest from image frame 202 and may then receive image frame 204 from the video camera (120 in FIG. 1, “no”).

The computing device can analyze image frame 204 (110 in FIG. 1) and perform motion detection using frame-to-frame differencing with image frame 202, image frame 200, and/or background subtraction methods. Because there is little to no change between image frame 200, image frame 202, and image frame 204, the computing device may not select a region of interest from image frame 204 and may then receive subsequent image frames from the video camera (120 in FIG. 1, “no”).

FIG. 2B is a diagram depicting a sequence of image frames from a video camera, consistent with certain disclosed embodiments. FIG. 2B is intended merely for the purpose of illustration and is not intended to be limiting.

As depicted in FIG. 2B, the sequence of image frames includes image frame 210, image frame 212, and image frame 214. Image frames 210, 212, and 214 represent image frames that can be captured by a video camera monitoring a parking lot and obtained by a computing device (e.g., 110 in FIG. 1).

For example, the computing device can first receive image frame 210 and subsequently receive image frame 212. The computing device can analyze image frame 212 (110 in FIG. 1) and perform motion detection using frame-to-frame differencing with image frame 210 and/or background subtraction methods. In some embodiments, because there are changes between image frame 210 and image frame 212, namely the appearance of vehicle 210A, the computing device may select a region of interest from image frame 212 (120 in FIG. 1, “yes”).

In other embodiments, because the pixels where motion was detected overlap one or more 3-D volumetric models, the computing device may select a region of interest from image frame 212. For example, the computing device may determine that the pixels where motion was detected overlap box 212A, which represents a 3-D volumetric model. Accordingly, the computing device can select a bounding box 212B that includes box 212A as a region of interest.

In still further embodiments, because tracked movement from frame to frame does not include a significant number of tracking points stopping at one of the volumetric models of a parking space or a significant number of tracking points leaving one of the volumetric models of a parking space, a selection of a region of interest may be postponed (120 in FIG. 1, “no”).

If a region of interest is selected in image frame 212, the computing device may then perform vehicle detection on the region of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 212B is not occupied as vehicle 210A is not substantially within box 212B and, accordingly, the computing device may determine that it is likely that no full vehicle is present in the region of interest represented by box 212B. Therefore, computing device may assign a low probability that the parking space model enclosed by box 212B is occupied.

Additionally, the computing device may determine that there is no change in parking status for the parking space model enclosed by box 212B because the parking space model was empty in image frame 210 and remains empty in image frame 212 (160 in FIG. 1, “no”). Accordingly, the computing device can analyze the next image frame (image frame 214).

In embodiments, the computing device can proceed directly to analyzing image frame 214 if a region of interest was not selected in image frame 212 (120 in FIG. 1, “no”). The computing device can analyze image frame 214 (110 in FIG. 1) and perform motion detection using frame-to-frame differencing with image frame 212, image frame 210, and/or background subtraction methods. In some embodiments, because there are changes between image frame 212 and image frame 214, namely the movement of vehicle 210A, the computing device may select a region of interest from image frame 214 (120 in FIG. 1, “yes”).

In other embodiments, because the pixels where motion was detected overlap one or more 3-D volumetric models, the computing device may select regions of interest from image frame 242. For example, the computing device may determine that the pixels where motion is detected overlap box 214A and 214B. Accordingly, the computing device can select bounding boxes 214C and 214D, which include boxes 214A and 214B, as regions of interest.

In still further embodiments, because tracked movement from frame to frame does not include a significant number of tracking points stopping at one of the volumetric models of a parking space or a significant number of tracking points leaving one of the volumetric models of a parking space from which they originated, a selection of a region of interest may be postponed (120 in FIG. 1, “no”).

If regions of interest are selected in image frame 214, the computing device may then perform vehicle detection on the regions of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 214C and the parking space model enclosed within the region of interest represented by box 214D are occupied as both boxes encompass a full vehicle and, accordingly, the computing device may have determined that it is likely that vehicles are present in the regions of interest represented by box 214C and box 214D. Therefore, the computing device may assign a high probability that the parking space models enclosed by boxes 214C and 214D are occupied.

Additionally, the computing device may determine that there is no change in parking status for the parking space models enclosed by boxes 214C and 214D because the parking space models were occupied in image frame 210 and/or image frame 212 and remain occupied in image frame 214 (160 in FIG. 1, “no”). Accordingly, the computing device can analyze the next image frame.

FIG. 2C is a diagram depicting a sequence of image frames from a video camera, consistent with certain disclosed embodiments. FIG. 2C is intended merely for the purpose of illustration and is not intended to be limiting.

As depicted in FIG. 2C, the sequence of image frames includes image frame 220, image frame 222, image frame 224, and image frame 226. Image frames 220, 222, 224, and 226 represent image frames that can be captured by a video camera monitoring a parking lot and obtained by a computing device (e.g., 110 in FIG. 1).

For example, the computing device can first receive image frame 220 and subsequently receive image frame 222. The computing device can analyze image frame 222 (110 in FIG. 1) and perform motion detection using frame-to-frame differencing with image frame 220 and/or background subtraction methods. In some embodiments, because there are changes between image frame 220 and image frame 222, namely the appearance of vehicle 220A, the computing device may select a region of interest from image frame 222 (120 in FIG. 1, “yes”).

In other embodiments, because the pixels where motion was detected overlap one or more 3-D volumetric models, the computing device may select a region of interest from image frame 222. For example, the computing device may determine that the pixels where motion was detected overlap box 220B, which represents a 3-D volumetric model. Accordingly, the computing device can select bounding box 220C, which includes box 220B, as a region of interest.

In still further embodiments, because tracked movement from frame to frame does not include a significant number of tracking points stopping at one of the volumetric models of a parking space or a significant number of tracking points leaving one of the volumetric models of a parking space from which they originated, a selection of a region of interest may be postponed (120 in FIG. 1, “no”).

If a region of interest is selected in image frame 222, the computing device may then perform vehicle detection on the region of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 220C is not occupied as vehicle 220A is not substantially within box 220C and, accordingly, the computing device may determine that it is likely that no full vehicle is present in the region of interest represented by box 220C. Therefore, computing device may assign a low probability that the parking space model enclosed by box 220C is occupied.

Additionally, the computing device may determine that there is no change in parking status for the parking space model enclosed by box 220C because the parking space model was empty in image frame 220 and remains empty in image frame 222 (160 in FIG. 1, “no”). Accordingly, the computing device can analyze the next image frame (image frame 224).

In embodiments, the computing device can proceed directly to analyzing image frame 224 if a region of interest was not selected in image frame 222 (120 in FIG. 1, “no”). The computing device can analyze image frame 224 (110 in FIG. 1) and perform motion detection using frame-to-frame differencing with image frame 222, image frame 220, and/or background subtraction methods. In some embodiments, because there are changes between image frame 222 and image frame 224, namely the movement of vehicle 220A, the computing device may select a region of interest from image frame 224 (120 in FIG. 1, “yes”).

In other embodiments, because the pixels where motion was detected overlap one or more 3-D volumetric models, the computing device may select regions of interest from image frame 224. For example, the computing device may determine that the pixels where motion was detected overlap box 220B. Accordingly, the computing device can select bounding box 220C, which includes box 220B, as a region of interest.

In still further embodiments, because tracked movement from frame to frame does not include a significant number of tracking points stopping at one of the volumetric models of a parking space or a significant number of tracking points leaving one of the volumetric models of a parking space from which they originated, a selection of a region of interest may be postponed (120 in FIG. 1, “no”).

If regions of interest are selected in image frame 224, the computing device may then perform vehicle detection on the regions of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 220C is occupied as it encompass a full vehicle and, accordingly, the computing device may determine that it is likely that a vehicle is present in the region of interest represented by box 220C. Therefore, the computing device may assign a high probability that the parking space model enclosed by box 220C is occupied.

Additionally, the computing device may determine that there is a change in parking status for the parking space model enclosed by box 220C because the parking space model was not occupied in image frame 220 and image frame 222 and is occupied in image frame 224 (160 in FIG. 1, “yes”). Accordingly, the computing device can update a parking status for the parking space model enclosed by box 220C, for example, in a local database. The computing device can then analyze the next image frame (image frame 226).

In embodiments, the computing device can proceed directly to analyzing image frame 226 if a region of interest was not selected in image frame 224 (120 in FIG. 1, “no”). The computing device can analyze image frame 226 (110 in FIG. 1) and perform motion detection using frame-to-frame differencing with image frame 224, image frame 222, image frame 220, and/or background subtraction methods. As depicted in image frames 220, 222, 224, and 226, a vehicle moves into a parking space model enclosed by box 220C and does not move further between image frames 224 and 226. Accordingly, in some embodiments, because tracked movement from frame to frame includes a significant number of tracking points (e.g., points associated with vehicle 220A) stopping at a volumetric model of a parking space enclosed by box 220C, the computing device can select a bounding box that includes box 220C as a region of interest.

The computing device may then perform vehicle detection on the regions of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 220C is occupied as it encompass a full vehicle and, accordingly, the computing device may determine that it is likely that a vehicle is present in the region of interest represented by box 220C. Therefore, the computing device may assign a high probability that the parking space model enclosed by box 220C is occupied.

Additionally, if a region of interest was not previously selected after vehicle 220A entered the parking space (e.g., image frame 224), the computing device may determine that there is a change in parking status for the parking space enclosed by box 220C because the parking space model associated with the parking space was not occupied previously and/or was not occupied in image frames 220 and image frame 222 and is occupied in image frame 226 (160 in FIG. 1, “yes”). Accordingly, the computing device can update a parking status for the parking space enclosed by box 220C, for example, in a local database. The computing device can then analyze the next image frame.

If a region of interest was previously selected in image frame 224, the computing device may have already updated the parking status for the parking space enclosed by box 220C (i.e., occupied), and, accordingly, may determine that there is no change in parking status for the parking space as vehicle 220A remains in the parking space model associated with the parking space (160 in FIG. 1, “no”). The computing device can then analyze the next image frame.

FIG. 2D is a diagram depicting a sequence of image frames from a video camera, consistent with certain disclosed embodiments. FIG. 2D is intended merely for the purpose of illustration and is not intended to be limiting.

As depicted in FIG. 2D, the sequence of image frames includes image frame 230, image frame 232, and image frame 234. Image frames 230, 232, and 234 represent image frames that can be captured by a video camera monitoring a parking lot and obtained by a computing device (e.g., 110 in FIG. 1).

For example, the computing device can first receive image frame 230 and subsequently receive image frame 232. The computing device can analyze image frame 232 (110 in FIG. 1) and perform motion detection using frame-to-frame differencing with image frame 230 and/or background subtraction methods. In some embodiments, because there are changes between image frame 230 and image frame 232, namely the movement of vehicle 230A, the computing device may select a region of interest from image frame 232 (120 in FIG. 1, “yes”).

In other embodiments, because the pixels where motion was detected overlap one or more 3-D volumetric models, the computing device may select a region of interest from image frame 232. For example, the computing device may determine that the pixels where motion was detected overlap box 230B, which represents a 3-D volumetric model. Accordingly, the computing device can select bounding box 230C, which includes box 230B, as a region of interest.

In still further embodiments, because vehicle 230A moves out of the center of a parking space model enclosed by box 230C, a computing device that is tracking points associated with vehicle 230A may determine that a significant number of tracking points are leaving the volumetric model of a parking space from which they originated and select a region of interest that includes box 230C (120 in FIG. 1, “yes”). In other embodiments, the computing device may determine that, because vehicle 230A partially remains within box 230C, a threshold number of tracking points leaving the volumetric model of the parking space from which they originated is not reached and may postpone a selection of a region of interest (120 in FIG. 1, “no”).

If a region of interest is selected in image frame 232, the computing device may then perform vehicle detection on the region of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 230C is not occupied as vehicle 230A is not substantially within box 230C and, accordingly, the computing device may determine that it is likely that no vehicle is present in the region of interest represented by box 230C. Therefore, computing device may assign a low probability that the parking space model enclosed by box 230C is occupied.

Additionally, the computing device may determine that there is a change in parking status for the parking space enclosed by box 230C because the parking space model associated with the parking space was occupied in image frames 230 and is not occupied in image frame 232 (160 in FIG. 1, “yes”). Accordingly, the computing device can update a parking status for the parking space enclosed by box 230C, for example, in a local database. The computing device can then analyze the next image frame (image frame 234).

Additionally, the computing device can proceed directly to analyzing image frame 234 if a region of interest was not selected in image frame 232 (120 in FIG. 1, “no”). The computing device can analyze image frame 234 (110 in FIG. 1) and perform motion detection using frame-to-frame differencing with image frame 232, image frame 230, and/or background subtraction methods. As depicted in image frames 230, 232, and 234, vehicle 230A moves out of the parking space model enclosed within box 230C. Accordingly, in some embodiments, if a region of interest was not selected based on vehicle 230A's movement between image frame 230 and image frame 232, because a significant number of tracking points leaving the volumetric model of a parking space from which they originated was not reached, the computing device can now select bounding box 230C that encloses box 230B as a region of interest.

The computing device may then perform vehicle detection on the region of interest. The computing device can use various vehicle detection algorithms known in the art, as described above. Based on the vehicle detection, the computing device can determine a probability that the parking space model within the region of interest is occupied. For example, the computing device may determine that the parking space model enclosed within the region of interest represented by box 230C is not occupied as no vehicle is within the box and, accordingly, the computing device may determine that it is likely that no vehicle is present in the region of interest represented by box 230C. Therefore, the computing device may assign a low probability that the parking space model enclosed by box 230C is occupied.

Additionally, if a region of interest was not selected before vehicle 230A left the parking space, the computing device may determine that there is a change in parking status for the parking space enclosed by box 230C because the parking space model associated with the parking space was occupied previously and/or in image frames 230 and possibly in image frame 232 and is not occupied in image frame 234 (160 in FIG. 1, “yes”). Accordingly, the computing device can update a parking status for the parking space enclosed by box 230C, for example, in a local database.

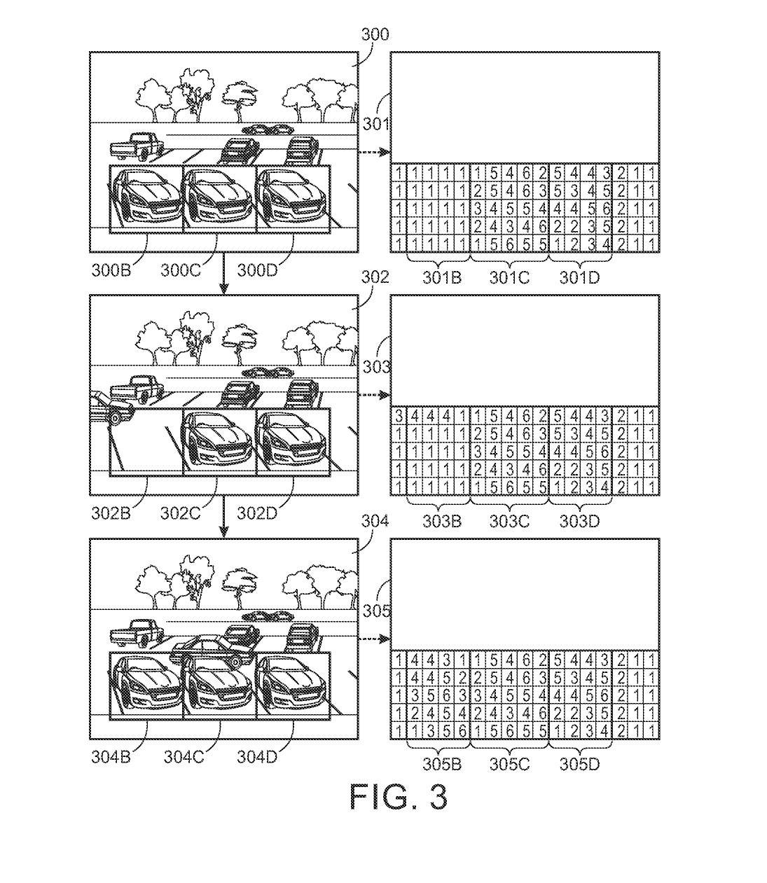

FIG. 3 is a diagram depicting a sequence of image frames from a video camera and exemplary pixel intensity values, consistent with certain disclosed embodiments. FIG. 3 is intended merely for the purpose of illustration and is not intended to be limiting.

As depicted in FIG. 3, the sequence of image frames includes image frame 300, image frame 302, and image frame 304. Image frames 300, 302, and 304 represent image frames that can be captured by a video camera monitoring a parking lot and obtained by a computing device (e.g., 110 in FIG. 1).

For example, the computing device can first receive image frame 300 and then can analyze image frame 300 (110 in FIG. 1). In embodiments, the computing device can monitor pixel intensities of pixels within each volumetric model of a parking space.

As depicted in FIG. 3, box 300B, box 300C and box 300D can represent 2-D bounding boxes of the 2-D renderings of 3-D volumetric models. Additionally, box 301 can represent a collection of pixel intensities measured for the bounding boxes of the three volumetric models of parking spaces from image frame 300. Box 301B can correspond to box 300B, box 301C can correspond to box 300C, and box 301D can correspond to box 300D. Accordingly, the pixel intensity measurements in the boxes from box 301 can represent pixel intensities measured from image frame 300.

The pixel intensities shown in FIG. 3 are merely for the purpose of illustration, are not intended to depict actual pixel intensities that may be measured, and are simplified for the purposes of this example. Accordingly, such exemplary pixel intensities are not intended to be limiting.

Based on the pixel intensities shown in boxes 301B, 301C, and 301D, the computing device may determine whether to select a region of interest. For example, the computing device may identify the pixel intensities of box 301B to be associated with an unoccupied parking space model. Accordingly, if a parking space model associated with box 300B was previously identified as occupied, box 300B from image frame 300 could be selected as a region of interest. Similarly, the computing device may identify the pixel intensities of box 301C to be associated with an occupied parking space model. Accordingly, if box 301C was previously identified as unoccupied, box 300C from image frame 300 could be selected as a region of interest.

Additionally or alternatively, if pixel intensities of boxes 301B, 301C, and 301D vary by an amount greater than a threshold compared to pixel intensities measured in the same location from previous image frames, a region of interest can be selected based on the corresponding box from image frame 300.

If a region of interest is selected, the process can proceed by performing vehicle detection, determining a probability that the parking space model is occupied, and changing a parking status, as described above. Then the computing device can analyze the next image frame (image frame 302).

Additionally, the computing device can proceed directly to analyzing image frame 302 if a region of interest was not selected in image frame 300 (120 in FIG. 1, “no”). The computing device can analyze image frame 302 (110 in FIG. 1). For example, the computing device can monitor pixel intensities of pixels within each volumetric model of a parking space.

As depicted in FIG. 3, box 302B, box 302C and box 302D can represent 2-D bounding boxes of the 2-D renderings of 3-D volumetric models. Additionally, box 303 can represent a collection of pixel intensities measured for the bounding boxes of the three volumetric models of parking spaces from image frame 302. Box 303B can correspond to box 302B, box 303C can correspond to box 302C, and box 303D can correspond to box 302D. Accordingly, the measurements in the boxes from box 303 can represent pixel intensities measured from image frame 302.

Based on the pixel intensities shown in boxes 303B, 303C, and 303D, the computing device may determine whether to select a region of interest. For example, the computing device may identify the majority of pixel intensities of box 303B and/or the pixel intensities for the central pixels of box 303B to be associated with an unoccupied parking space model. Accordingly, a region of interest may not be selected for a parking space model associated with box 302B because the parking space model associated with box 302B was previously identified as unoccupied in image frame 300. Similarly, the computing device may identify the pixel intensities of box 303C to be associated with an occupied parking space model. Accordingly, a region of interest may not be selected for a parking space model associated with box 302C because the parking space model associated with box 302C was previously identified as occupied in image frame 300.

Additionally or alternatively, the pixel intensities of boxes 303C and 303D do not vary at an amount greater than a threshold compared to pixel intensities measured in the same location from image frame 300. Accordingly, a region of interest may not be selected for the corresponding boxes from image frame 302. Similarly, the pixel intensities only vary at the top of the parking space model for box 303B compared to box 301B from image frame 300. Accordingly, a region of interest may not be selected as changes in pixel intensities around the edge of a parking space model may not indicate a change in parking status.

If a region of interest is selected, the process can proceed by performing vehicle detection, determining a probability that the parking space model is occupied, and changing a parking status if necessary, as described above. Then the computing device can analyze the next image frame (image frame 304).

Additionally, the computing device can proceed directly to analyzing image frame 304 if a region of interest was not selected in image frame 302 (120 in FIG. 1, “no”). The computing device can analyze image frame 304 (110 in FIG. 1). For example, the computing device can monitor pixel intensities of pixels within each volumetric model of a parking space.

As depicted in FIG. 3, box 304B, box 304C, and box 304D can represent 2-D bounding boxes of the 2-D renderings of 3-D volumetric models. Additionally, box 305 can represent a collection of pixel intensities measured for the bounding boxes of the three volumetric models of parking spaces from image frame 304. Box 305B can correspond to box 304B, box 305C can correspond to box 304C, and box 305D can correspond to box 304D. Accordingly, the measurements in the boxes from box 305 can represent pixel intensities measured from image frame 304.

Based on the pixel intensities shown in boxes 305B, 305C, and 305D, the computing device may determine whether to select a region of interest. For example, the computing device may identify the majority of pixel intensities of box 305B and/or the pixel intensities for the central pixels of box 305B to be associated with an occupied parking space model. Accordingly, a region of interest may be selected for a parking space model associated with box 304B because the parking space model associated with box 304B was previously identified as unoccupied in image frames 300 and 302. Similarly, the computing device may identify the pixel intensities of box 305C to be associated with an occupied parking space model. Accordingly, a region of interest may not be selected for a parking space model associated with box 304C because the parking space model associated with box 304C was previously identified as occupied in image frames 300 and 302.

Additionally or alternatively, the pixel intensities of boxes 305B can vary at an amount greater than a threshold compared to pixel intensities measured in the same location from image frames 300 and/or 302. Accordingly, a region of interest may be selected that encloses the corresponding box from image frame 304 (box 304B). Additionally, the pixel intensities also vary at the center of the parking space model for box 305B compared to box 303B from image frame 302 and box 301B from image frame 300. Accordingly, a region of interest may be selected even when a computing device only selects a region of interest when pixel intensities at the center of a parking space model vary in intensity at an amount greater than a threshold.

If a region of interest is selected, the process can proceed by performing vehicle detection, determining a probability that the parking space model is occupied, and changing a parking status, as described above. Then the computing device can analyze the next image frame.

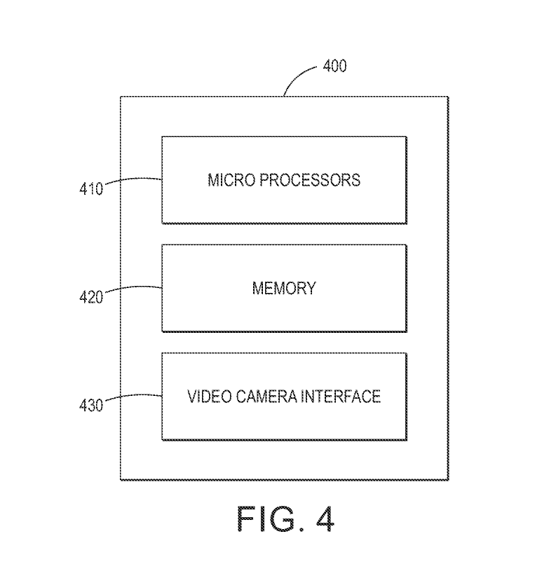

FIG. 4 is a diagram illustrating an exemplary hardware system for determining parking occupancy, consistent with certain disclosed embodiments. Computing device 400 may represent any type of one or more computing devices.

Computing device 400 may include, for example, one or more microprocessors 410 of varying core configurations and clock frequencies; one or more memory devices or computer-readable media 420 of varying physical dimensions and storage capacities, such as flash drives, hard drives, random access memory, etc., for storing data, such as images, files, and program instructions for execution by one or more microprocessors 410; etc. One or more microprocessors 410, and one or more memory devices or computer-readable media 420 may be part of a single device as disclosed in FIG. 4 or may be contained within multiple devices. Those skilled in the art will appreciate that the above-described componentry is exemplary only, as computing device 400 may comprise any type of hardware componentry, including any necessary accompanying firmware or software, for performing the disclosed embodiments. Further, computing device 400 can include, for example, video camera interface 430 for communication with one or more video cameras.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments. The steps described need not be performed in the same sequence discussed or with the same degree of separation. Likewise, various steps may be omitted, repeated, or combined, as necessary, to achieve the same or similar objectives or enhancements. Accordingly, the present disclosure is not limited to the above-described embodiments, but instead is defined by the appended claims in light of their full scope of equivalents.

What is claimed is:

1. A system for determining parking occupancy, the system comprising:
one or more video cameras;
a processing system comprising one or more processors capable of receiving data from the one or more video cameras; and
a memory system comprising one or more computer-readable media, wherein the one or more computer-readable media contain instructions that, when executed by the processing system, cause the processing system to perform operations comprising:
constructing a parking area model based on a parking area, wherein the parking area model comprises one or more parking space models, each associated with a parking space in the parking area;
receiving a set of image frames for the parking area from the one or more video cameras;
selecting a region of interest within an image frame from the set of image frames;
performing vehicle detection on the region of interest within the image frame;
determining that there is a change in parking status for a parking space model associated with the region of interest; and
updating parking status information for a parking space associated with the parking space model based on determining that there is a change in parking status.

2. The system of claim 1, wherein the one or more parking space models are three-dimensional volumetric models.

3. The system of claim 2, wherein constructing the three-dimensional volumetric models comprises:
receiving a preliminary set of image frames for the parking area from the one or more video cameras;
determining a parking lot layout based on the preliminary set of image frames for the parking area;
estimating parking space volume for the parking spaces models within the parking lot layout based on a viewing angle of the one or more video cameras; and
estimating a probability that a pixel from the preliminary set of image frames belongs to a particular parking space model.

4. The system of claim 1, wherein selecting the region of interest within the image frame from the set of image frames comprises selecting the region of interest based on detected motion between the image frame and at least one previous image frame.

5. The system of claim 4, wherein the region of interest is selected based on the detected motion overlapping a parking space model from the parking area model.

6. The system of claim 1, the operations further comprising tracking points of an object associated with a region of an image frame where motion is detected within the set of image frames.

7. The system of claim 6, wherein the region of interest is selected based on at least one of:
a determination that a threshold number of tracking points stopped at a parking space model from the parking area model; and
a determination that a threshold number of tracking points leave a parking space model, from the parking area model, from which they originated.

8. The system of claim 1, the operations further comprising monitoring pixel intensities of pixels within each image frame of the set of image frames, wherein:
the region of interest is selected based on a determination that pixel intensities of monitored pixels vary greater than a threshold amount between image frames; and
the monitored pixels are associated with at least one of the one or more parking space models.

9. The system of claim 1, the operations further comprising monitoring pixel intensities of pixels within each image frame of the set of image frames, wherein the region of interest is selected based on a determination that, between image frames, pixel intensities change from pixel intensities associated with occupied parking space models to pixel intensities associated with non-occupied parking space models.

10. The system of claim 6, the operations further comprising:
monitoring pixel intensities of pixels within each image frame of the set of image frames:
classifying pixels within each image frame as one of vehicle and non-vehicle in a biased probabilistic manner, wherein the classification is:
biased towards vehicle pixels relative to non-vehicle pixels when a determination is made that a threshold number of tracking points stopped at a parking space model from the parking area model; and
biased towards non-vehicle pixels relative to vehicle pixels when a determination is made that a threshold number of tracking points leave a parking space model, from the parking area model, from which they originated.

11. A method for determining parking occupancy, comprising:
constructing a parking area model based on a parking area, wherein the parking area model comprises one or more parking space models, each associated with a parking space in the parking area;
receiving a set of image frames for the parking area from one or more video cameras;
selecting a region of interest within an image frame from the set of image frames;
performing vehicle detection on the region of interest within the image frame;
determining that there is a change in parking status for a parking space model associated with the region of interest; and
updating parking status information for a parking space associated with the parking space model based on determining that there is a change in parking status.

12. The method of claim 11, wherein the one or more parking space models are three-dimensional volumetric models.

13. The method of claim 12, wherein constructing the three-dimensional volumetric models comprises:
receiving a preliminary set of image frames for the parking area from the one or more video cameras;
determining a parking lot layout based on the preliminary set of image frames for the parking area;
estimating parking space volume for the parking spaces models within the parking lot layout based on a viewing angle of the one or more video cameras; and
estimating a probability that a pixel from the preliminary set of image frames belongs to a particular parking space model.

14. The method of claim 11, wherein selecting the region of interest within the image frame from the set of image frames comprises selecting the region of interest based on detected motion between the image frame and at least one previous image frame.

15. The method of claim 14, wherein the region of interest is selected based on the detected motion overlapping a parking space model from the parking area model.

16. The method of claim 11, further comprising tracking points of an object associated with a region of an image frame where motion is detected within the set of image frames.

17. The method of claim 16, wherein the region of interest is selected based on at least one of:
a determination that a threshold number of tracking points stopped at a parking space model from the parking area model; and
a determination that a threshold number of tracking points leave a parking space model, from the parking area model, from which they originated.

18. The method of claim 11, further comprising monitoring pixel intensities of pixels within each image frame of the set of image frames, wherein:
the region of interest is selected based on a determination that pixel intensities of monitored pixels vary greater than a threshold amount between image frames; and
the monitored pixels are associated with at least one of the one or more parking space models.

19. The method of claim 11, further comprising monitoring pixel intensities of pixels within each image frame of the set of image frames, wherein the region of interest is selected based on a determination that, between image frames, pixel intensities change from pixel intensities associated with occupied parking space models to pixel intensities associated with non-occupied parking space models.

20. The method of claim 16, further comprising:
monitoring pixel intensities of pixels within each image frame of the set of image frames:
classifying pixels within each image frame as one of vehicle and non-vehicle in a biased probabilistic manner, wherein the classification is:
biased towards vehicle pixels relative to non-vehicle pixels when a determination is made that a threshold number of tracking points stopped at a parking space model from the parking area model; and
biased towards non-vehicle pixels relative to vehicle pixels when a determination is made that a threshold number of tracking points leave a parking space model, from the parking area model, from which they originated.
